(19) United States
(12) Patent Application Publication
(10) Pub. No.: US 2026/0029570 A1
(43) Pub. Date: Jan. 29, 2026

(54) OPTICAL FIBER CABLE INCLUDING OPTICAL FIBERS HAVING INTERMITTENTLY SPACED WATER-BLOCKING BANDS

(71) Applicant: CORNING RESEARCH & DEVELOPMENT CORPORATION, Corning, NY (US)

(72) Inventor: Michael Alexander Heinz, Berlin (DE)

(21) Appl. No.: 19/343,152

(22) Filed: Sep. 29, 2025

Related U.S. Application Data
(63) Continuation of application No. PCT/US2024/021832, filed on Mar. 28, 2024.
(60) Provisional application No. 63/456,822, filed on Apr. 4, 2023.

(51) Int. Cl. G02B 6/02; C03C 25/106; C03C 25/26

(52) U.S. Cl. CPC G02B 6/02042; C03C 25/106; C03C 25/26; G02B 6/02395

(57) ABSTRACT

An optical fiber cable is provided. The optical fiber cable includes a cable jacket having an inner surface and an outer surface. The inner surface defines a central bore, and the outer surface defines an outermost surface of the optical fiber cable. At least one subunit is disposed within the central bore, and each of the at least one subunit includes a subunit jacket surrounding a plurality of optical fibers. At least one optical fiber of the plurality of optical fibers in each of the at least one subunit includes bands of water-blocking material that are intermittently spaced along a length of the at least one optical fiber. The water-blocking material is configured to absorb at least 20 grams of water per gram of water-blocking material.

### CROSS-REFERENCE TO RELATED APPLICATION

This application is a continuation of International Patent Application No. PCT/US2024/021832, filed on Mar. 28, 2024, which claims the benefit of priority of U.S. Provisional Application No. 63/456,822, filed on Apr. 4, 2023, the content of which is relied upon and incorporated herein by reference in its entirety.

### BACKGROUND

The disclosure relates generally to optical fiber cables and, in particular, to optical fiber cables including optical fibers with bands of water-blocking material.

Optical fibers are used to carry data throughout a telecommunications network. In general, there is a demand for higher speeds and larger capacities, which generally corresponds to a need for optical fiber cables containing more optical fibers. Further, it is desirable to increase the fiber count while maintaining the same cable size so that the cable is compatible with existing ductwork. Including more fibers within a cable of a given size increases the fiber density and decreases the available free space for movement of the optical fibers to avoid attenuation during bending. In view of the limited free space at high fiber densities, conventional cable structures, such as water-blocking powders or yarns, that do not present an issue at low fiber density and high free space can become sources of attenuation.

### SUMMARY

According to an aspect, embodiments of the disclosure relate to a subunit. The subunit includes a subunit jacket having an interior surface and an exterior surface. The interior surface defines a central channel extending along a longitudinal axis of the subunit. A plurality of optical fibers is disposed within the central channel of the subunit jacket. A cross-sectional area of the central channel perpendicular to the longitudinal axis comprises a free space of no more than 50%. At least one optical fiber of the plurality of optical fibers includes bands of water-blocking material that are intermittently spaced along a length of the at least one optical fiber. The water-blocking material configured to absorb at least 20 grams of water per gram of water-blocking material.

According to another aspect, embodiments of the disclosure relate to an optical fiber cable. The optical fiber cable includes a cable jacket having an inner surface and an outer surface. The inner surface defines a central bore, and the outer surface defines an outermost surface of the optical fiber cable. At least one subunit is disposed within the central bore, and each of the at least one subunit includes a subunit jacket surrounding a plurality of optical fibers. At least one optical fiber of the plurality of optical fibers in each of the at least one subunit includes bands of water-blocking material that are intermittently spaced along a length of the at least one optical fiber. The water-blocking material is configured to absorb at least 20 grams of water per gram of water-blocking material.

According to still another aspect, embodiments of the disclosure relate to a method of for forming a subunit of an optical fiber cable. In the method, a water-blocking material is intermittently applied to at least one optical fiber to form a plurality of bands along a length of the at least one optical fiber. The water-blocking material configured to absorb at least 20 grams of water per gram of water-blocking material. A subunit jacket is formed around the at least one optical fiber to form the subunit.

Additional features and advantages will be set forth in the detailed description that follows, and, in part, will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and the operation of the various embodiments. In the drawings:

FIG. 1 depicts a cross-sectional view of an optical fiber cable having optical fibers arranged in a plurality of subunits, in particular lumens, according to an exemplary embodiment;

FIG. 2 depicts an optical fiber having intermittent bands of water-blocking material, according to an exemplary embodiment;

FIG. 3 depicts an optical fiber having groupings of intermittent bands of water-blocking material, according to an exemplary embodiment;

FIG. 4 depicts a bundle of optical fibers having intermittent bands of water-blocking material, according to an exemplary embodiment;

FIG. 5 depicts a ribbon with optical fibers intermittently bonded with bands of water-blocking material, according to an exemplary embodiment;

FIG. 6 depicts a flow diagram of a first method of applying bands of water-blocking material to individual optical fibers, according to an exemplary embodiment; and

FIG. 7 depicts a flow diagram of a second method of applying bands of water-blocking material to groups of optical fibers, according to an exemplary embodiment.

### DETAILED DESCRIPTION

Referring generally to the figures, various embodiments of an optical fiber cable containing optical fibers having bands of water-blocking material are provided. As will be discussed more fully below, the optical fibers are grouped by a subunit jacket into subunits having a low free space, and because of the low free space, conventional water-blocking materials may not be suitable for use within the subunits. Notwithstanding, the low free space also means that less water-blocking material is needed to prevent the spread of water that infiltrates a cable. Thus, as described herein, bands of water-blocking material are intermittently applied along the length of one or more optical fibers within the subunit. In embodiments, the water-blocking material can be clear or include a colorant, in particular taking the place of conventional ring-marking of optical fibers. In other embodiments, the water-blocking material can be applied between optical fibers to connect optical fibers into a rollable or foldable ribbon structure. The exemplary embodiments of optical fiber cables having optical fibers with intermittent bands of water-blocking material will be described in greater detail below and in relation to the figures provided herewith, and these exemplary embodiments are provided by way of illustration, and not by way of limitation.

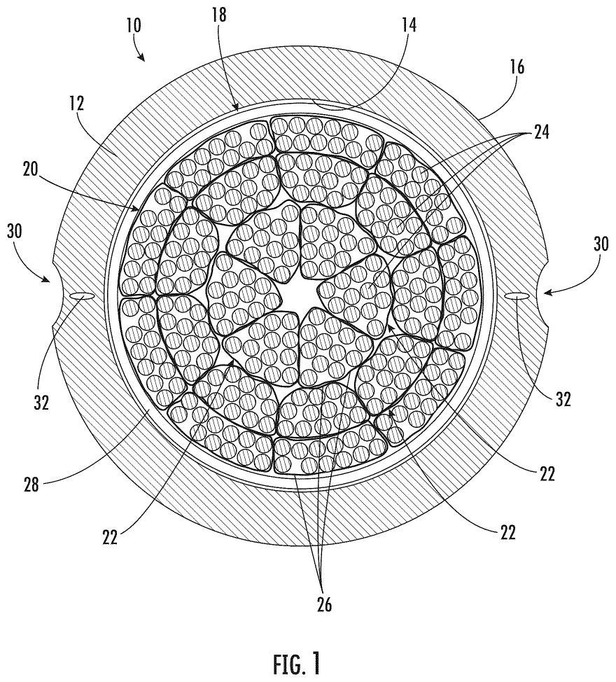

FIG. 1 depicts an example embodiment of an optical fiber cable 10, in particular a high fiber density optical fiber cable 10. The optical fiber cable 10 includes a cable jacket 12 having an inner surface 14 and an outer surface 16. The inner surface 14 of the optical fiber cable 10 defines a central bore 18 that extends along a longitudinal axis of the optical fiber cable 10. Disposed within the central bore 18 of the optical fiber cable 10 is cable core 20. In the embodiment shown in FIG. 1, the cable core 20 includes a plurality of subunits 22. The subunits 22 each include a subunit jacket 26 having an interior surface defining a central channel that extends along a longitudinal axis of the subunit 22 and an exterior surface defining the outermost surface of the subunit 22. A plurality of optical fibers 24 are disposed in the central channel such that the plurality of optical fibers 24 is surrounded by the subunit jacket 26.

In one or more embodiments, the interior surface of the subunit jacket 26 defines an interior cross-sectional area of the subunit 22 that is perpendicular to the longitudinal axis of the subunit 22. The portion of this interior cross-sectional area that is not occupied by the optical fibers 24 is referred to as “free space.” In one or more embodiments, each subunit 22 comprises a free space of 50% or less, 40% or less, 30% or less, or 25% or less. In one or more embodiments, each subunit 22 comprises a free space of 20% or more. The low free space within the subunits 22 provides a high fiber density for the optical fiber cable 10.

In one or more embodiments, the subunit jacket 26 groups from two to ninety-six in particular from eight to thirty-six, and particularly from twelve to twenty-four, optical fibers 24 into a subunit 22.

In one or more embodiments, including the embodiment depicted in FIG. 1, the subunit jacket 26 is a thin and flexible sheath referred to as a “membrane,” and the subunit 22 is a reconfigurable subunit referred to as a “lumen.” Specifically, the membrane is a thin and flexible sheath that allows for the lumen to be reconfigured into a variety of different shapes. In this way, the lumens can be densely packed within the cable core 20 by changing shape, e.g., flattening out, bunching up, or bending, as necessary to fill space within the cable core 20. Notwithstanding, other types of subunits 22 can be used in the cable core 20, such as buffer tube subunits as will be discussed below.

In one or more embodiments in which the subunits 22 are lumens and the subunit jackets 26 are membranes, the membrane of each lumen is formed from a polymer material, such as a polyethylene, a polypropylene, a polyester (e.g., polyethylene terephthalate or polybutylene terephthalate), a polystyrene, a polycarbonate, a polyamide, a polytetrafluoroethylene, or copolymers or blends thereof. In one or more such embodiments, the membrane includes a filler material dispersed in the polymer material. In one or more embodiments, the membrane is configured to be torn by an operator's fingers (i.e., without requiring any specialized tools) in a manner that does not damage the optical fibers 24 contained therein. The thinness of the polymer material, the use of fillers, and/or the blend of polymers in the polymer material may contribute to the ability of the membrane to torn by an operator's fingers.

In one or more embodiments in which the subunit 22 is a lumen and the subunit jacket 26 is a membrane, the thickness of the membrane is 75 μm or less, 70 μm or less, 65 μm or less, 60 μm or less, 55 μm or less, 50 μm or less, 45 μm or less, 40 μm or less, or 35 μm or less. In one or more embodiments, the thickness of the membrane is 5 μm or more, 10 μm or more, 15 μm or more, 20 μm or more, 25 μm or more, or 30 μm or more. In one or more embodiments, the thickness of the membrane is from 5 μm to 50 μm.

In one or more embodiments in which the subunits 22 are buffer tube subunits and the subunit jackets 26 are buffer tubes, the buffer tube of each buffer tube subunit is formed from a polymer material, such as a polycarbonate, a polystyrene, a polyimide, a polysulfone, an aromatic polyester, a polyphenylene sulfide, a polyetherimide, a polyaryletherketone (e.g., polyether ether ketone), a polymethylmethacrylate, a liquid crystalline polymer, a cyclic olefin copyolymer, a polybutylene terephthalate, a polycarbonate/polybutylene terephthalate blend or composite structure, a polycarbonate/polyethylene terephthalate blend or composite structure, a polyolefin, or a polyamide. In one or more embodiments, the buffer tube is a rigid, circular tube that substantially holds it shape when formed into a cable core 20 (in particular, in comparison to a reconfigurable lumen).

In one or more embodiments in which the subunits 22 are buffer tube subunits and the subunit jackets 26 are buffer tubes, an outer diameter of each buffer tube is 4 mm or less. In one or more embodiments, an inner diameter of the buffer tube is at least 0.8 mm. In one or more embodiments, a wall thickness of each buffer tube (i.e., distance between the interior surface and the exterior surface) is 1 mm or less, in particular 0.75 mm or less, and most particularly 0.5 mm or less. In one or more embodiments, the wall thickness of each buffer tube is at least 0.1 mm.

In one or more embodiments, the subunits 22 (e.g., lumen or buffer tube subunit) may be stranded (such as SZ-stranded) in the cable core 20. The stranding provides the ability to bend the cable while minimizing tensile and contractive forces within any of the optical fibers 24. During cable bending, the subunits 22 may be configured to move relative to each other in certain embodiments by using solid or gel lubricants, such as talc, or using water-absorbing powders.

In one or more embodiments, the cable core 20 is surrounded by a binder 28. In one or more embodiments, the binder 28 is a thin film jacket having a thickness between 40 μm and 150 μm. In one or more embodiments, the binder 28 is made from, e.g., linear low-density polyethylene (LLDPE). In one or more other embodiments, the binder 28 is a wrap or tape that is wound around the cable core 20.

In one or more embodiments, the cable jacket 12 has a thickness of between 0.5 mm and 2 mm. In particular embodiments, the cable jacket 12 has a thickness that is from 8% to 10% of the outer diameter of the optical fiber cable 10.

In one or more embodiments, the cable jacket 12 includes tactile locator features 30. In the embodiment depicted, the tactile locator features 30 comprise diametrically arranged depressions defined by the outer surface 16 of the cable jacket 12. However, in one or more other embodiments, the tactile locator features 30 comprise diametrically arranged bumps defined by the outer surface 16 of the cable jacket 12. The tactile locator features 30 assist a user in opening the cable 10 by guiding the user to the location of access features 32. In the embodiment of the optical fiber cable 10 depicted in FIG. 1, the access features 32 are strips of dissimilar polymer embedded in the polymer of the cable jacket 12. For example, the cable jacket 12 may substantially comprise polyethylene, and the dissimilar polymer of the access feature 32 may be polypropylene. The immiscibility of the polyethylene of the cable jacket 12 and the polypropylene of the access features 32 prevents a strong bond from forming between the cable jacket 12 and the access features 32, allowing for a user to tear through the cable jacket 12 in the region of the access features 32. Further, once opened at the access features 32, the cable jacket 12 can be split along its length along the access features 32.

In one or more embodiments, the optical fiber cable 10 may also include water blocking material (e.g., tapes, yarns, or powders) around or between the subunits 22, lubricants, friction-enhancing materials, or strength elements (e.g., fiber-reinforced plastic rods, metal wires, or tensile yarns) embedded in the cable jacket 12.

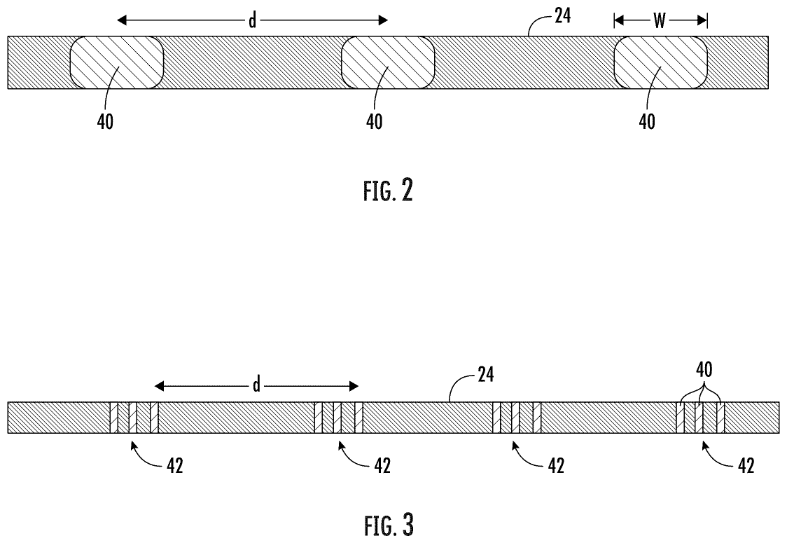

According to the present disclosure, one or more of the optical fibers 24 in at least one subunit 22 of the optical fiber cable 10 include water-blocking bands 40 applied intermittently along the length of the optical fiber 24 within the optical fiber cable 10. FIG. 2 depicts an example of an optical fiber 24 including water-blocking bands 40.

As shown in FIG. 2, the optical fiber 24 includes a plurality of bands 40 made of water-blocking material. In one or more embodiments, the water-blocking bands 40 are comprised of a material having a water absorbing capacity of at least 20 g/g (i.e., 20 grams of water per gram of water-blocking material). In one or more embodiments, the water-blocking bands 40 are comprised of a material having a water absorbing capacity of at least 40 g/g. In one or more embodiments, the water-blocking bands 40 are comprised of a material having water absorbing capacity of at least 80 g/g. In one or more embodiments, the water-blocking bands 40 are comprised of a material having water absorbing capacity of up to 200 g/g.

According to embodiments of the present disclosure, the material of the water-blocking bands 40 is a UV-cured resin that is formed from a solvent-free, UV-curable material. One example of commercially available solvent-free, UV-curable material for the water-blocking bands 40 is BLOCKCOAT® from Artofil (Deurne, Netherlands). Other water-blocking materials may also be used, such as a superabsorbent swellable hot melt or such as a coating having superabsorbent polymer powder dispersed therein, amongst other possibilities.

In one or more embodiments, the bands 40 extend around the entire circumference of the optical fiber 24. In one or more embodiments, the bands 40 extend only partially around the circumference of the optical fiber 24, e.g., extending up to 30%, up to 50%, or up to 70% of the circumference of the optical fiber 24. In one or more embodiments, the bands 40 have a width W of up to 5 mm. In one or more embodiments, the bands 40 have a width W of at least 0.5 mm. In one or more embodiments, the bands 40 have a width W in a range of from 1 mm to 5 mm. In one or more embodiments, the bands 40 have a thickness of up to 20 μm. In one or more embodiments, the bands 40 have a thickness of at least 1 μm. In one or more embodiments, the bands 40 have a thickness in a range of 1 μm to 20 μm microns, in particular 2 μm to 10 μm.

The bands 40 are intermittently spaced along the length of the optical fiber 24. In one or more embodiments, the bands 40 are spaced apart by a distance d (e.g., distance between fronts, midpoints, or backs of successive bands 40). In one or more embodiments, the distance d is from 30 mm to 300 mm, in particular 40 mm to 65 mm, 75 mm to 125 mm. or 225 mm to 275 mm. Further, in one or more embodiments, the bands 40 are arranged in groupings 42 as shown in FIG. 3, and the groupings are spaced apart by the distance d. That is, the first band 40 of a first grouping 42 is spaced the distance d from the first band 40 of a second grouping 42. In one or more embodiments, adjacent bands 40 within a grouping 40 are spaced apart by 1 mm to 10 mm, in particular 1.5 mm to 8 mm. In this way, the water-blocking bands 40 can replace ring-markings on optical fibers 24 for the purpose of identification.

In particular, a subunit 22 containing a plurality of optical fibers 24 may use color-coding to distinguish between optical fibers. One typical color-coding scheme uses the following sequence of colors: blue, orange, green, brown, gray, white, red, black, yellow, violet, pink, and aqua. This color-coding scheme works for subunits 22 containing up to twelve optical fibers 24. For subunits 22 containing more than twelve optical fibers 24, ring-marking may be used to restart the color-coding sequence. For example, a first set of twelve optical fibers 24 may be color-coded, and a second set of twelve optical fibers 24 may be color-coded and include intermittently-spaced ring markings. A third set of twelve optical fibers 24 may be color-coded and include intermittently-spaced groupings of two ring markings, and a fourth set of twelve optical fibers 24 may be color-coded and include intermittently-spaced groupings of three ring markings (e.g., as shown in FIG. 3). As shown in FIGS. 2 and 3, the optical fiber 24 is depicted with a first hatching to denote a coating of a first color applied to the optical fiber 24, and the bands 40 are depicted with a second hatching to denote a water-blocking material of a second color distinguishable from the first color. Notwithstanding, the bands 40 may be applied with a clear water-blocking material in certain embodiments.

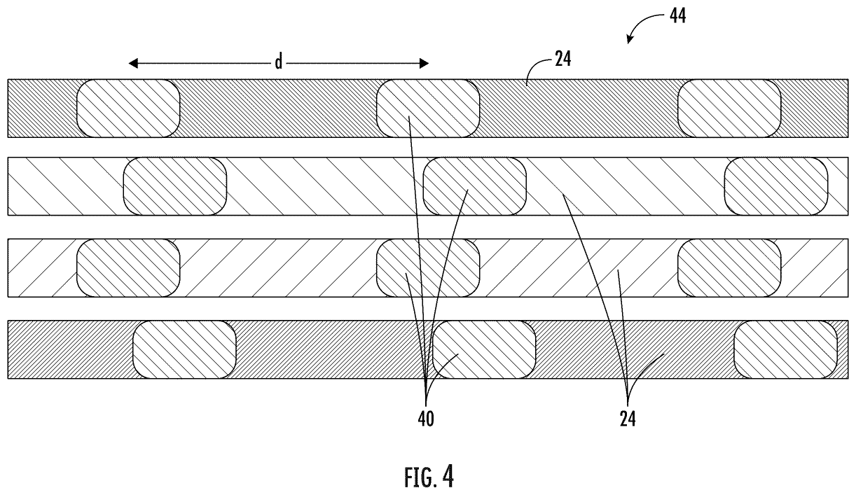

In one or more embodiments, the bands 40 of water blocking material is applied to individual optical fibers 24 as shown in FIGS. 2 and 3. However, in one or more other embodiments, the bands 40 of water blocking material are applied to bundles 44 of optical fibers 24 as shown in FIG. 4. In particular, during processing as will be discussed more fully below, the optical fibers 24 may be arranged in bundles 44, and the water-blocking material may be applied to multiple optical fibers 24 within the bundle 44 in a single step. As shown in FIG. 4, the optical fibers 24 are each depicted with a different hatching to denote coatings of different colors (e.g., according to a color-coding scheme), and the bands 40 are depicted with a different hatching to denote a water-blocking material of another color distinguishable from the colors of the optical fibers 24. For example, an optical fiber 24 with an orange coating may have a band 40 of a black water-blocking material, and an optical fiber 24 with a black coating may have a band 40 of yellow or white water-blocking material. However, the bands 40 may be applied with a clear water-blocking material in certain embodiments.

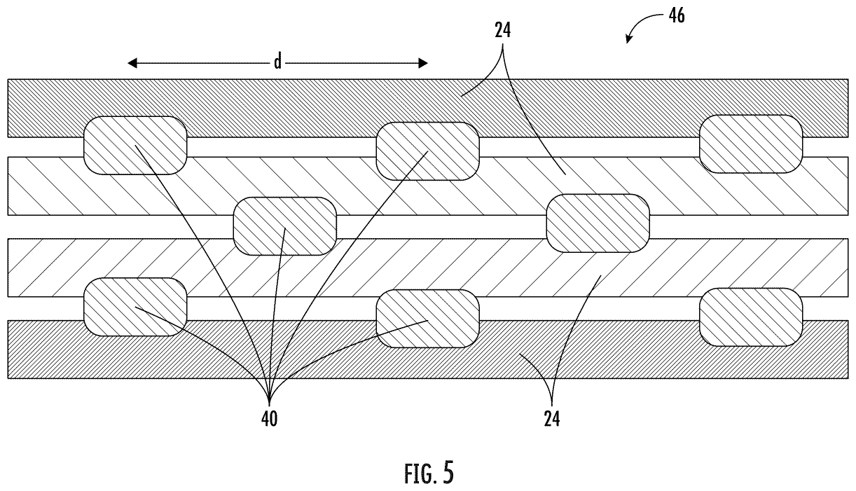

Additionally, as shown in FIG. 5, the water-blocking material may be applied between optical fibers 24 to form an intermittently-bonded optical fiber ribbon 46 in one or more embodiments. Such an intermittently-bonded ribbon 46 can be reversibly rolled, folded, or collapsed from a planar configuration to a non-planar to decrease the space occupied by the optical fiber ribbon 46. In such embodiments, the optical fibers 24 of each ribbon 46 may be color-coded according to a particular scheme, and the bands 40 of each ribbon may also be color-coded. For example, a ribbon 46 of twelve optical fibers 24 may be color-coded with the blue-aqua scheme described above, and ribbons 46 may be distinguished from each other based on the color of the bands 40 applied to each ribbon 46 (e.g., bands 40 of a first ribbon 46 being blue, bands 40 of a second ribbon 46 being orange, etc.). As with the previously discussed embodiments,

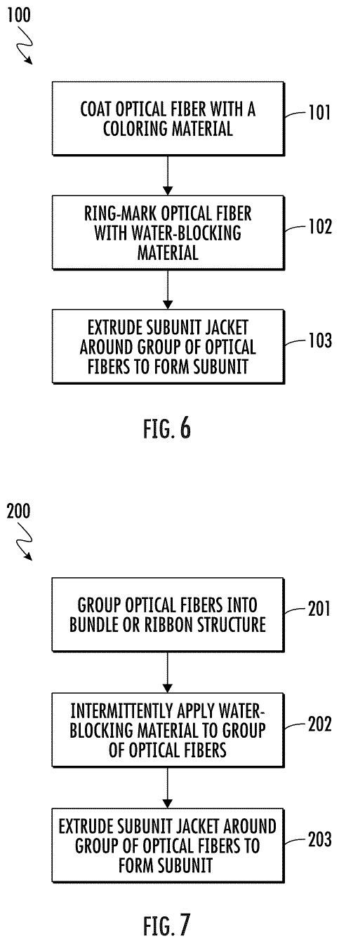

FIG. 6 depicts a first flow diagram of a method 100 for applying the water-blocking bands 40 to individual optical fibers 24. In a first step 101, an optical fiber 24 is coated with a coloring material (e.g., an ink coating, such a UV-curable ink). In a second step 102, the optical fiber 24 undergoes ring marking using the water-blocking material. In one or more embodiments, the water-blocking material includes a colorant (e.g., a dye or a pigment) to provide a color ring-marking to the optical fiber 24. However, in one or more other embodiments, the water-blocking material is substantially clear such that the band 40 is not visible (e.g., for a first set of optical fibers 24), and thereafter, a water-blocking material having a colorant can be used for bands 40 to provide ring marking for identification. In one or more embodiments, the water-blocking material can be applied by any of a variety of suitable applicators (such as an inkjet printer or an oscillating wetted roller), by dipping the optical fiber 24 in the water-blocking material, or by painting or printing the water-blocking material over a masked optical fiber 24.

In one or more embodiments, the water-blocking material can be applied after coloring using conventional ring marking equipment by replacing the conventional ring marking ink with the water-blocking material (either clear or containing a colorant). In one or more other embodiments, the water-blocking material can be applied using other equipment, such as on a processing line with an inkjet printer and (e.g., UV, heat, or ambient) curing station (if needed). In still another embodiment, the water-blocking material is applied to the individual optical fibers 24 on the same processing line immediately prior to bundling the optical fibers 24 and extruding the polymer material of the subunit jacket 26 around the bundled optical fibers 24. Advantageously, it is easier to apply the water-blocking material prior to extruding the subunit jacket 26 around the optical fibers 24 because the optical fibers 24 are moving slower than, e.g., the optical fibers 24 on a ring marking processing line.

After the water-blocking material is applied to the individual optical fibers 24, the subunit jacket 26 is extruded around a plurality of such optical fibers 24 to form a subunit 22 of an optical fiber cable 10 in a third step 103. Thereafter, one or more subunits 22 are arranged into a cable core 20, and the cable jacket 12 is extruded around the cable core 20 to provide an optical fiber cable 10.

FIG. 7 depicts another embodiment of a method 200 for applying the water-blocking bands 40 to a plurality of optical fibers 24. In one or more embodiments, the method 200 includes a first step 201 of arranging a plurality of optical fibers into a group. In one or more embodiments, the group can be a bundle of optical fibers 24. In one or more embodiments, the group can be a planar arrangement of optical fibers 24 for forming a ribbon structure. In a second step 202 of the method 200, the water-blocking material is applied to the grouped optical fibers 24. In the case of a bundle, an applicator may apply the water-blocking material across multiple optical fibers 24 at the same time. For example, as the optical fibers 24 are being bundled together into the group, water-blocking material can be sprayed (e.g., using one or more printers) across the almost touching optical fibers 24.

In the case of a planar arrangement of optical fibers 24, the applicator may selectively apply the water-blocking material between adjacent optical fibers 24 to connect the adjacent optical fibers 24. Thereafter, in a third step 203, a subunit jacket 26 is extruded around the group of optical fibers 24 to form a subunit 22 of an optical fiber cable 10. Thereafter, one or more subunits 22 are arranged into a cable core 20, and the cable jacket 12 is extruded around the cable core 20 to provide an optical fiber cable 10.

Advantageously, applying the water-blocking material intermittently in bands along the length of the optical fibers reduces the amount of water-blocking material needed for a given length of cable. Further, by using less material, the water-blocking material can cure to a greater degree and at a faster speed on-line. Additionally, the optical fiber cable may perform better (e.g., experience decreased attenuation) at lower temperature because of the reduced amount of material inside the subunit compared to a full-length coating of water-blocking material, thereby permitting more room for optical fibers to reconfigure during thermal contraction. Still further, the reduced amount of material means that the addition of the water-blocking bands minimally affects the burn performance of the optical fiber cable. Moreover, the water-blocking material can be applied using existing application methods, such as ring marking systems, or using known technologies, such as inkjet printing.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A subunit, comprising:
a subunit jacket having an interior surface and an exterior surface, the interior surface defining a central channel extending along a longitudinal axis of the subunit; and
a plurality of optical fibers disposed within the central channel of the subunit jacket;
wherein a cross-sectional area of the central channel perpendicular to the longitudinal axis comprises a free space of no more than 50%; and
wherein at least one optical fiber of the plurality of optical fibers comprises bands of water-blocking material that are intermittently spaced along a length of the at least one optical fiber, the water-blocking material configured to absorb at least 20 grams of water per gram of water-blocking material.

2. The subunit of claim 1, wherein the bands are intermittently spaced apart by a distance in a range from 30 mm to 300 mm.

3. The subunit of claim 1, wherein the bands are arranged into groupings, and the groupings are intermittently spaced apart by a distance in a range from 30 mm to 300 mm.

4. The subunit of claim 3, wherein adjacent bands within each grouping of the groupings are spaced apart by 1 mm to 10 mm.

5. The subunit of claim 1, wherein the bands have a width of up to 5 mm.

6. The subunit of claim 1, wherein the bands have a thickness of up to 20 μm.

7. The subunit of claim 1, wherein the water-blocking material comprises a solvent-free, UV-curable resin; a superabsorbent swellable hot melt; or a coating having superabsorbent polymer powder dispersed therein.

8. The subunit of claim 1, wherein each optical fiber of the plurality of optical fibers is intermittently bonded to an adjacent optical fiber by the bands of water-blocking material.

9. The subunit of claim 1, wherein the bands extend around an entire circumference of the at least one optical fiber.

10. The subunit of claim 1, wherein the bands extend around less than an entire circumference of the at least one optical fiber.

11. The subunit of claim 1, wherein the plurality of optical fibers comprises at least twenty-four optical fibers, wherein the at least twenty-four optical fibers comprises a first set of twelve optical fibers and a second set of twelve optical fibers, wherein the first set of twelve optical fibers is color-coded according to a first scheme and includes bands of clear water-blocking material, and wherein the second set of twelve optical fibers is color-coded according to the first scheme and includes bands of water-blocking material comprising a colorant.

12. The subunit of claim 11, wherein the subunit jacket is a buffer tube having a wall thickness in a range of 0.1 mm to 1 mm.

13. The subunit of claim 11, wherein the subunit jacket is a membrane having a thickness of at most 75 μm.

14. An optical fiber cable, comprising:
a cable jacket comprising an inner surface and an outer surface, the inner surface defining a central bore and the outer surface defining an outermost surface of the optical fiber cable; and
at least one subunit disposed within the central bore, each of the at least one subunit including a subunit jacket surrounding a plurality of optical fibers;
wherein at least one optical fiber of the plurality of optical fibers in each of the at least one subunit includes bands of water-blocking material that are intermittently spaced along a length of the at least one optical fiber, the water-blocking material being configured to absorb at least 20 grams of water per gram of water-blocking material.

15. A method of forming a subunit of an optical fiber cable, comprising:
intermittently applying a water-blocking material to at least one optical fiber to form a plurality of bands along a length of the at least one optical fiber, the water-blocking material configured to absorb at least 20 grams of water per gram of water-blocking material;
forming a subunit jacket around the at least one optical fiber to form the subunit.

16. The method of claim 15, wherein intermittently applying comprises inkjet printing the water-blocking material onto the at least one optical fiber.

17. The method of claim 15, wherein the plurality of bands intermittently bonds a plurality of optical fibers together into a ribbon structure.

18. The method of claim 15, further comprising the step of applying a color coating to the at least one optical fiber prior to intermittently applying the water-blocking material.

19. The method of claim 15, wherein intermittently applying comprises applying the water-blocking material around an entire circumference of the at least one optical fiber.

20. The method of claim 15, wherein the water-blocking material comprises a solvent-free, UV-curable resin; a superabsorbent swellable hot melt; or a coating having superabsorbent polymer powder dispersed therein.
